(19) United States
(12) Patent Application Publication
(10) Pub. No.: US 2024/0011463 A1
(43) Pub. Date: Jan. 11, 2024

(54) METHOD OF OPTIMIZING A ROTOR BLADE, ROTOR BLADE AND WIND TURBINE

(71) Applicant: Wobben Properties GmbH, Aurich (DE)

(72) Inventors: Jochen Stemberg, Aurich (DE); Muhanad Mahmoud, Aurich (DE); Janani Kumar, Aurich (DE)

(21) Appl. No.: 18/349,782

(22) Filed: Jul. 10, 2023

(30) Foreign Application Priority Data
Jul. 11, 2022 (EP) 22184041.6

(51) Int. Cl. F03D 1/06; F03D 80/00

(52) U.S. Cl. CPC F03D 1/0675; F03D 80/00; F05B 2260/96; F05B 2240/30

(57) ABSTRACT

A method of optimizing a rotor blade of a wind turbine as well as to an associated rotor blade, and to a wind turbine, wherein the rotor blade extends from a rotor-blade coupling to a rotor-blade tip in a rotor-blade longitudinal direction with a rotor-blade length, having an aerodynamical profile extending between a leading edge and a trailing edge, wherein the method comprises the following steps: designing the rotor blade for design environmental conditions including at least one design air density, with the designing comprising providing a sound-protection means within a blade external region of the rotor blade, the latter being defined as the 50% of the rotor-blade length abutting the rotor-blade tip; providing an air density at the installation site of the wind turbine; comparing the air density with the design air density; and increasing the induction factor by upsizing the sound-protection means in case the air density is lower than the design air density.

### BACKGROUND

### Technical Field

The invention relates to a method of optimizing a rotor blade of a wind turbine, to a rotor blade of a rotor of a wind turbine, and to a wind turbine, and a wind farm.

### Description of the Related Art

Wind turbines have been generally known and configured as exemplarily shown in FIG. 1. The design of the rotor blade(s) is a crucial aspect when it comes to emissions and the efficiency of the wind turbine. The rotor blades of a wind turbine usually have a suction side and a pressure side. The suction side and the pressure side converge along the rotor-blade trailing edge of the rotor blade, in short trailing edge. The pressure difference between the suction side and the pressure side allows for vortexes to be created which may lead to noise emission and power reduction, in particular at the tip of the rotor blade. Further, when there are flows around the blade surface, small vortexes and pressure variations are caused by friction effects at the pressure side and at the suction side which may lead to noise emission when flowing over the rotor-blade trailing edge.

Wind turbines and their components, respectively, are designed in line with standardized guidelines (e.g., IEC 61400) which address the essential design requirements to ensure technical integrity of wind turbines. The aim of this standard is to provide an appropriate level of protection against damages from hazards during the planned service life of the wind turbine. Here, standard parameters, which depend on a standardized load but are not site specific, are considered when dimensioning the wind turbine. Among others, the standard parameters are wind shear, occurrence of turbulences, climatic conditions, air density, reference speeds for wind classes and wind zones. As the dimensioning of the rotor blades depends on the standardized load, they have a defined profile with fixed parameters such as profile depth including profile polars, e.g. lift/drag polars, associated therewith. This fixed profile is the basis for calculating load and the annual energy output (AEO).

The design of a wind turbine, and the configuration of the rotor blades resulting therefrom, are mainly based on a standardized site, and a standardized load, respectively, with site-specific proofs/loads possibly being considered. Thereby the later geometrical configuration of the rotor blades is determined. In particular, the rotor blades have a fixed geometry which cannot be adapted later during manufacturing as regards twist or profile depth.

### BRIEF SUMMARY

Provided are techniques for a site-specific optimization of rotor blades without changing the fixed geometry.

In a first aspect, a method of optimizing a rotor blade of the wind turbine is provided, wherein the rotor blade extends from a rotor blade coupling to a rotor blade tip in a longitudinal direction of the rotor blade with a rotor blade length, having an aerodynamic profile extending between a leading edge and a trailing edge. Thus, it is a basically known rotor blade which can be optimized by the methods described herein.

The method comprises the following steps: designing the rotor blade for design environmental conditions which include at least a design air density, wherein designing comprises providing a sound protection means within a blade external region of the rotor blade defined as the 50% of the rotor blade length abutting the rotor blade tip.

The process of designing wind turbines has been well known and described extensively in common textbooks. Given the underlying design conditions, e.g., a design speed and/or a design tip speed ratio, a configuration of the rotor blades is usually desired which is not only as efficient and durable as possible but cost-effective.

The design conditions also comprise design environmental conditions, i.e., conditions modeling the environment at the installation site of the wind turbine under design conditions. Thus, the design environmental conditions are theoretic environmental conditions on which the design is based but which do not necessarily prevail at the proper installation site of the wind turbine. The deviations between design environmental conditions and the environmental conditions prevailing at the installation site of the wind turbine may lead to loss of performance, e.g. Here, the most important thing to consider is an air density which is lower at an installation site than the design air density. For example, the design air density may be a standard air density but also be a different value.

To this end, an air density is provided at the installation site of the wind turbine in a further step. This air density can be determined as an average value or an extreme value or another value representing the air density at the installation site. For example, the air density may be measured, or deduced from meteorological models.

In the further step, provided are techniques for comparing the air density with the design air density, and increasing the induction factor by upsizing the sound-protection means when the air density is lower than the design air density.

Thus, when an air density is obtained at the installation site of the wind turbine that is lower than the design air density, the sound-protection means are sized up inventively to increase the induction factor and thus the performance.

The underlying finding of the inventors is based on the sound-protection means also increasing the effective profile depth and thus the buoyancy produced at the site where the sound-protection means is attached.

When an air density is lower than the design air density, two effects are produced. Firstly, the noise generated is lower, providing for the possibility to make also aero-acoustic trade-offs which lead to higher noise emissions. Moreover, the induction is lower, leading to a lower performance and thus to the wish to increase the performance.

In this case, the upsizing of the sound-protection means allows for a site-based optimization, and in particular for optimizing the performance of the rotor blade, without changing the geometry of the rotor blade.

Sound-protection means may include for example serrations arranged at the trailing edge of the rotor blade or solid plate add-ons.

There may also be combinations of multiple types of sound-protection means arranged on a rotor blade.

In a preferred embodiment, the sound-protection means is configured as serrations with several spikes arranged side by side in rotor-blade longitudinal direction, with the latter being arranged in a way that a serrated contour of the effective trailing edge is formed in the region of the sound-protection means, wherein the step of increasing the induction factor comprises: at least one of a plurality of options for upsizing one or more of the spikes.

In one embodiment, the method includes upsizing one or more of the spikes by scaling the spikes geometrically similarly, wherein a relationship of a length of the spikes to the width of the spikes remains substantially the same.

In one embodiment, the method includes upsizing one or more of the spikes by increasing the length of the spikes while not changing the width of the spikes.

In one embodiment, the method includes upsizing one or more of said spikes by reducing a share of perforations of a surface of said spikes.

In one embodiment, the method includes upsizing one or more of said spikes by increasing a convexity of lateral edges of said spike.

In one embodiment, the method includes upsizing one or more of said spikes by changing a triangular shape of said spike to a multi-angle shape.

Serrations are a known type of sound-protection means which are arranged at the trailing edge and modify an effective contour of the trailing edge, i.e., a flow-off edge. Thus, the acoustic effects of the air turbulences at the trailing edge of the rotor blade are reduced, and the wind turbine can be operated with a lower noise level.

When scaling geometrically similarly, the relationship of length to width of the spikes remains substantially the same. Other options include increasing only the length of the spikes, with the width of the spikes remaining the same. Combinations are conceivable as well, wherein, e.g., a doubled length is associated with a width increase of 50%.

Serrations are most commonly shaped triangular but also multi-angle serrations or serrations having concave and/or convex contour may be considered within the scope of this invention. In a triangular shape, the serrations occupy fifty percent of the area beyond the trailing edge, i.e., of the region having the serrated contour. Modifying the edge contour, for instance by shaping the edges convex or by modifying the shape to multi-angle, the share of area covered by the serrations with regard to the total area beyond the trailing edge can be increased, such increasing the induction factor.

Thus, the upsizing can consist of making the individual serrations larger in either width or length. Alternatively or additionally, the upsizing can include changing the external geometry of the serrations, for instance by shaping the edges convex or by modifying the number of corners, for instance to four, five or seven.

In a preferred embodiment, the step of increasing the induction factor comprises adjusting an installation angle of the sound-protection means, with an installation angle being defined as the angle between a local chord of the rotor blade and the sound-protection means, and in particular the spikes of the serrations, wherein the local chord is defined as direct connection of the leading edge and the trailing edge at the site of the sound-protection means.

The serrations change the effective profile depth, and accordingly, the installation angle of the serrations changes the curvature of the profile. By adjusting the installation angle, it is particularly possible to change the curvature of the profile, and to influence the buoyancy produced.

Adjusting the installation angle can be carried out by installing the sound-protection means with a different installation angle to the rotor blade than the installation angle resulting from design conditions. Installing the serrations may comprise laminating the serrations into the rotor blade. In other examples, the installation angle can be adjusted by bending the serrations through application of mechanical force.

In particular a rounded shape in airfoil direction can increase the lift and therefore the induction factor. In this embodiment, the sound-protection means act similar to a flap or slat.

In a preferred embodiment, the method further comprises the following steps: determining the influence of the air density on the propagated sound, optimizing the performance while considering the air density and the guaranteed sound power level, and in particular optimizing the performance by upsizing the sound-protection means.

Optimizing the performance specifically includes maximizing the generated electrical power of the wind turbine. At the same time, the increase in performance must not result in excess sound emissions.

The guaranteed sound power level is a measure that describes the maximum emitted sound power level of the wind turbine. Expressed differently, wind turbine control includes the emitted sound level as a boundary condition when maximizing electrical power, for instance. In some cases the operation of the wind turbine is then limited or restricted by the guaranteed sound power level. This may apply temporarily, for instance during night time or specific wind directions.

As a further example, the installation angle of the sound-protection means could be changed to optimize the power while considering the air density and the guaranteed sound power level.

Usually, lower air densities are associated with lower sound powers so that there is also a “sound in reserve” that may be increased, e.g., by additional power. The additional power is not only achieved by adapting the operation management but first and foremost by increasing the induction in the blade tip region, i.e., by upsizing the sound-protection means.

In a preferred embodiment, the step of increasing the induction factor comprises increasing the extension of the sound-protection means in rotor-blade longitudinal direction, and in particular increasing a number of spikes of serrations.

Alternative to increasing the number of spikes, the existing ones may also be scaled, i.e., the length and/or the width of the spikes may be increased. In any case, in this configuration, the additional induction produced by the sound-protection means is increased.

In a preferred embodiment, the step of increasing the induction factor comprises upsizing the sound-protection means by a scaling factor varying in rotor-blade longitudinal direction.

The essential aspect of this configuration is the different effect of the sound-protection means depending on the position in rotor-blade longitudinal direction. Thus, the induction can be increased inventively, without the tolerated additional sound emissions produced exceeding a certain threshold value.

In a preferred embodiment, the scaling factor increases from the rotor-blade tip towards the end of the sound-protection means.

With this configuration, the finding is taken into account that the sound-protection means strongly influences the sound produced, in particular in the surroundings of the rotor-blade tip. To comply with the sound-emission limitations, it is thus advantageous to upsize the sound-protection means in a larger distance to the rotor-blade tip to a correspondingly higher extent.

With one configuration, the scaling factor at the rotor-blade tip is substantially 1. This means that there is no upsizing of the sound-protection means at the rotor-blade tip, but the sound-protection means becomes correspondingly larger the more the distance to the rotor-blade tip increases. The upsizing factor can be linear, square or increase in a different functional relationship with the distance of the rotor-blade tip.

In a further aspect, a rotor blade of a wind turbine is provided, wherein the rotor blade extends from a rotor-blade coupling to a rotor-blade tip in a rotor-blade longitudinal direction with a rotor-blade length, having an aero-dynamic profile extending between a leading edge and a trailing edge, wherein the rotor blade has a sound-protection means within a blade exterior region defined as the 50% of the rotor-blade length abutting the rotor-blade tip, with the sound-protection means being formed as serrations with multiple spikes arranged side by side in rotor-blade longitudinal direction, the latter being arranged such that a serrated contour of the effective trailing edge in the region of the sound-protection means is formed, wherein a design size is defined for the sound-protection means at which the rotor blade complies with the guaranteed sound power level when it is used at a design air density.

The sound-protection means has a larger size than the design size in case the air density is lower than the design air density.

Accordingly, the inventive rotor blade is the direct result of the inventive method according to the inventive aspect described. Further, the preferred embodiments of the method described are similarly applicable to the rotor blade, achieving the same advantages.

In a further aspect, a wind turbine with one or more inventive rotor blades is proposed.

Finally, in a further aspect, a wind farm with one or more inventive wind turbines is proposed.

With the inventive wind turbine, and the inventive wind farm, it is also possible to achieve the same advantages as with the inventive rotor blade, and the inventive method described. Likewise, both the wind turbine and the wind farm can be combined with the embodiments described as advantageous, achieving the advantage described.

### BRIEF DESCRIPTION OF THE SEVERAL VIEWS OF THE DRAWINGS

In the following, further advantages and preferred embodiments are described with reference to the appended figures. In the figures,

FIG. 1 shows a wind turbine schematically and exemplarily;

FIGS. 2-6 show a rotor blade with a sound-protection means schematically and exemplarily; and

FIG. 7 shows a flow chart of a method schematically and exemplarily.

### DETAILED DESCRIPTION

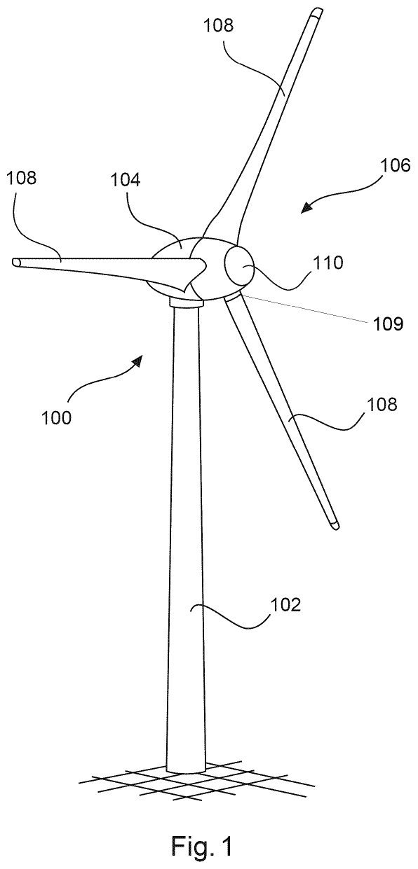

FIG. 1 shows a schematic of a wind turbine. The wind turbine 100 has a tower 102 and a nacelle 104 on the tower 102. On the nacelle 104, an aerodynamic rotor 106 is provided which has three rotor blades 108 and a spinner 110. When the wind turbine is operated, the aerodynamic rotor 106 is put into rotational movement by the wind, thus also rotating an electrodynamic rotor, or runner, of a generator which is directly or indirectly coupled to the aerodynamic rotor 106. The electric generator is arranged within the nacelle 104 and produces electric power. The pitch angle of the rotor blades 108 can be changed by pitch motors at the rotor-blade roots 109 of the respective rotor blades 108.

Here, the wind turbine 100 has an electric generator 101 which is indicated in the nacelle 104. Using the generator 101, electric power can be produced. To feed electric power, a feeding unit 105 is provided which, in particular, can be embodied as an inverter. Here, a three-phase feeding current and/or a three-phase feeding voltage can be produced depending on amplitude, frequency, and phase, to be fed to a mains supply point PCC. This can be done directly or in cooperation using further wind turbines in a wind farm. To control the wind turbine 100, and also the feeding unit 105, a turbine control 103 is provided. The turbine control 103 can also obtain default values from the outside, and, in particular, from a central farm computer.

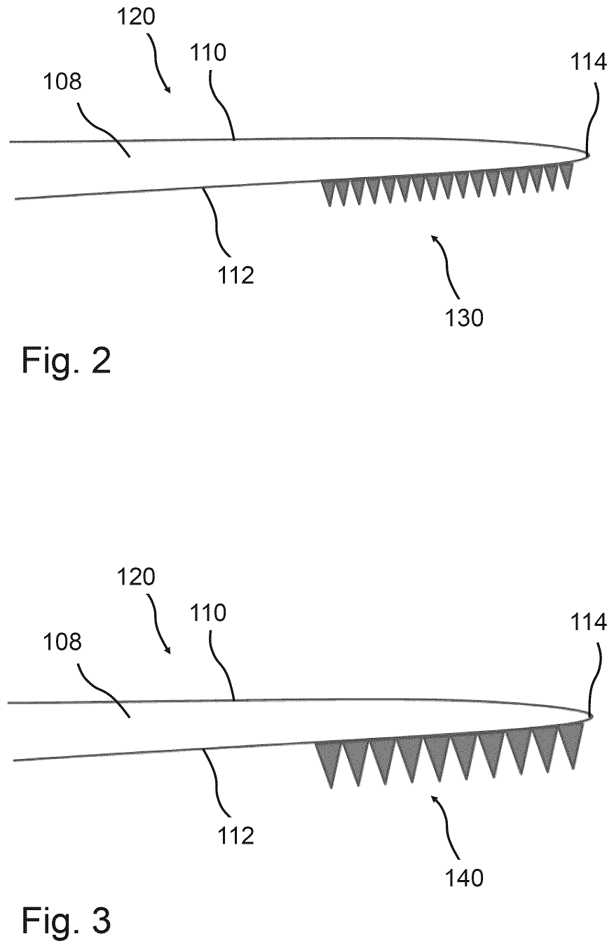

FIG. 2 shows schematically and exemplarily a blade external region 120 of the rotor blade 108. The blade external region 120 is defined as the outer 50% of the rotor blade 108 which are arranged closer to a blade tip 114, and thus farther away from an axis of rotation of the rotor 106. In the blade external region 120, the rotor blade 108 has a sound-protection means 130 which extends beyond a trailing edge 112. At the trailing edge 112, the suction side and the pressure side of the aerodynamic profile which diverge at a leading edge 110 converge again.

The sound-protection means 130 is embodied as serrations which also form a serrated, sawtooth-like contour with alternating tips and notches connected by edges arranged at an angle to the rotor-blade longitudinal direction. Thus, the trailing-edge contour is formed by the serrations in the region of the sound-protection means 130.

The serrations can be described by their length, width, and installation angle. The relationship between length and width defines the angle to the rotor-blade longitudinal direction. The installation angle describes the angle of the serration to a chord of the rotor blade at an installation position of the serration, with the chord being the shortest, and most direct, connection between the leading edge and the trailing edge.

The disclosure relates to the geometric configuration of the rotor blade 108 in the blade external region 120 for optimizing the induction factor with wind turbines 100 at sites with low air density.

By default, serrations are installed in the blade external region 120 for sound reduction. Simulations and experimental studies of the inventors of the present disclosure have shown clearly that the buoyancy at the rotor blade 108, and thus the induction factor, can be increased by extending the serrations, i.e., by increasing the length of the single spikes over the trailing edge 112 which would be the case without sound-protection means 130 to more than the default length.

By extending the serrations, an effective increase in the local blade depth is achieved, i.e., of the local distance between the leading edge 110 and the trailing edge 112, since the serrations influence the contour of the trailing edge 112. Thereby, the buoyancy-generating surface area is increased.

The air density depends on the temperature and the atmospheric pressure. At sea level, at a temperature of 15° C. and at an atmospheric pressure of 1,013.25 hPa (which is the standard atmosphere) it is 1.225 kg per m³. The air density decreases with altitude. The air density exerts a strong influence on the power of the wind, i.e., the wind power, with a higher air density being associated with higher wind powers, and thus also higher achievable electric powers of the wind turbines 100.

A wind turbine 100 is designed for certain environmental parameters, i.e., during the planning process boundary conditions are defined, e.g., a design air density with respect to which the wind turbine 100 will be optimized later. To achieve the design air density, an optimal operation of the wind turbine is possible, with variations from the design air density usually leading to the scenario that the wind turbine 100 which cannot be operated at the optimal operating site fixed during the planning process.

At the same time, it is not possible to design, and test, an individual wind turbine for each site so that there is a need for wind turbines 100, and in particular rotor blades 108, the application range of which is as broad as possible.

At sites where the air density is significantly lower than the design air density, a reduced induction factor will generally be case when a standard operation management is done. A reduced induction factor means that the wind turbine 100 gathers less energy from the wind and thus, the performance of the wind turbine 100 decreases.

Prior efforts to increase performance focused on adapting the operation management (e.g., increasing the speed and/or decreasing the pitch angle to increase the local angle of attack) to compensate for the induction losses. However, this results in an increase of the service life loads in pivot direction caused by the increased speed, e.g. Further, an increase of the local work angles may lead to flow stalls at the blade (little stall reserve), which might result in higher loads and in noise exposure.

A solution with an upsized sound-protection means, and in particular with extended serrations, is proposed which allows for the induction factor to be adjusted without having to accept higher pivoting loads and smaller stall reserves.

Advantages described herein reside in that significant power, and thus output, increases can be achieved at sites with reduced density by using serrations which are longer/larger than the design serrations for standardized sites.

FIG. 3 shows schematically and exemplarily a rotor blade 108 wherein the sound-protection means 130 of FIG. 2 have been replaced with a sound-protection means 140 having geometrically similarly size-scaled serrations. The serrations of the sound-protection means 140 are geometrically scaled, i.e., an aspect ratio of the serration spikes remains the same from length to width. Thus, the number of spikes is less than with the sound-protection means 130, however, the surface area, and thus the influence on the induction, are higher.

The upsizing of the serrations used may be realized both by a geometrically similar scaling (an aspect ratio of the serration spikes remains the same from length to width) and by extending the spike geometry without changing the original width (ratio of the serration spikes from length to width becomes larger).

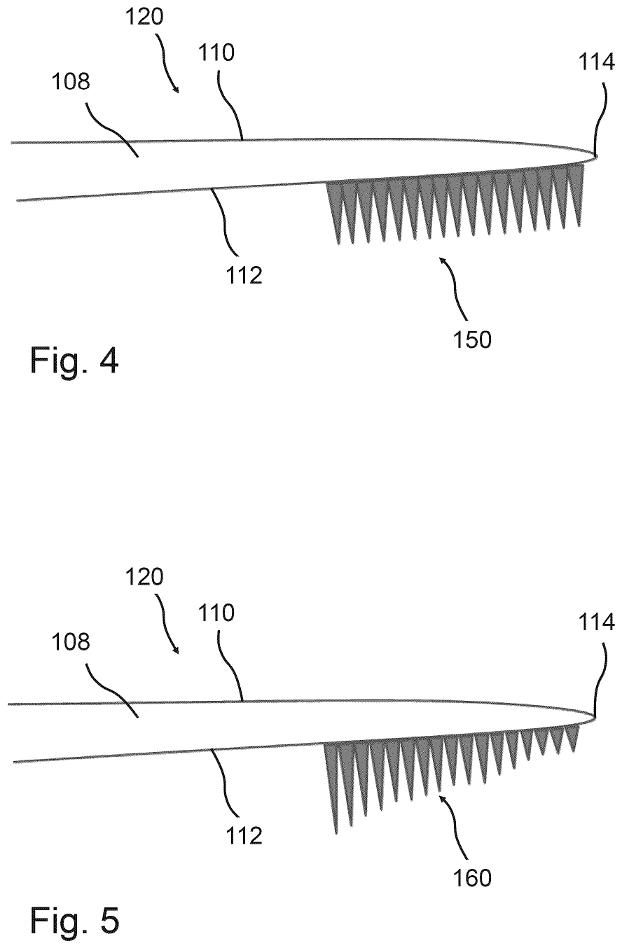

The second alternative of extending the spike geometry without changing the original width can be seen schematically and exemplarily in the sound-protection means 150 of FIG. 4.

In addition to upsizing the serrations, the installation angle can also be adapted (not shown) to further increase buoyancy. The installation angle is the angle between the serrations and the chord of the rotor blade 108. A positive installation angle can be defined towards the pressure side, a negative angle towards the suction side. An adaptation towards the pressure side leads to an increase of the buoyancy because the curvature is increased.

A particular advantage of sites with reduced density is that the wind turbine 100 also propagates less sound when the air density is lower. Thus, an aero-acoustically optimal design of serration is usually no longer a must at such sites.

Aero-acoustical trade-offs can be accepted in favor of the performance without exceeding the guaranteed sound power levels.

FIG. 5 shows schematically and exemplarily a further embodiment of the sound-protection means 160. The size scaling of the serrations, i.e., the geometrically similar scaling shown in FIG. 3 and/or the scaling of the spike length shown in FIG. 4, does not necessarily have to be the same along the entire radial extension. Rather, depending on the position, also scaling factors differing from the standard density design can be used. For example, in the aero-acoustically important region of the blade tip, a design can be used which is acoustically rather optimal while further inwards at the rotor blade, a serration scaling can be used which is performance optimized.

This is shown in FIG. 5 wherein almost no upsizing of the sound-protection means 160 has been done at the rotor-blade tip 114, whereas the sound-protection means 160 becomes more upsized with increasing distance to the rotor-blade tip 114.

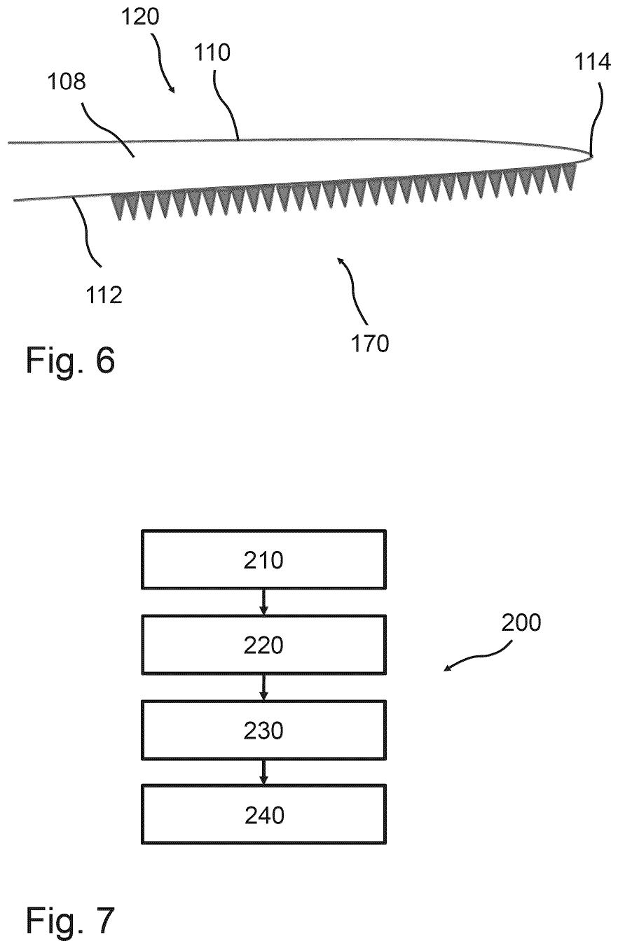

FIG. 6 shows schematically and exemplarily a further embodiment of the sound-protection means 170. A further way to increase the performance at sites with reduced density is to extent also the region in which sound-protection means 170 are to be mounted, e.g., in which further serrations are to be mounted. The additional serrations mounted at the rotor blade further inwards can effectively increase the induction factor in this region.

Of course, the sound-protection means 170 which become more upsized in rotor-blade longitudinal direction can also be site-specifically scaled in size and width, i.e., be combined with the embodiments shown in FIGS. 3, 4 and 5.

FIG. 7 shows schematically and exemplarily a flow of a method 200 of optimizing a rotor blade 108 of a wind turbine 100.

The method 200 comprises a step 210 of designing the rotor blade 108 for design environmental conditions which include at least a design air density, wherein designing comprises providing a sound protection means 130 within a blade external region of the rotor blade defined as the 50% of the rotor blade length abutting the rotor blade tip.

In addition, the method 200 comprises a step 220 of providing an air density at the installation site of the wind turbine 100, and a step 230 of comparing the air density with the design air density.

Finally, the method 200 comprises a step 240 of increasing the induction factor by upsizing the sound-protection means 130, e.g., towards sound-protection means 140, 150, 160 or 170 in case the air density is lower than the design air density.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of optimizing a rotor blade of a wind turbine, wherein the rotor blade extends from a rotor-blade coupling to a rotor-blade tip in a rotor-blade longitudinal direction with a rotor-blade length, wherein the rotor blade has an aerodynamical profile extending between a leading edge and a trailing edge, wherein the method comprises:
designing the rotor blade for design environmental conditions including at least one design air density, wherein the designing comprises providing a sound-protection means within a blade external region of the rotor blade, the blade external region being defined as the 50% of the rotor-blade length abutting the rotor-blade tip;
providing an air density at the installation site of the wind turbine;
comparing the air density with the design air density; and
increasing and induction factor by upsizing the sound-protection means when the air density is lower than the design air density.

2. The method according to claim 1, wherein the sound-protection means is configured as a plurality of serrations with a plurality of spikes arranged side by side in the rotor-blade longitudinal direction, wherein the rotor-blade longitudinal direction is arranged in a way that a serrated contour of the effective trailing edge is formed in a region of the sound-protection means.

3. The method according to claim 2, wherein increasing the induction factor comprises upsizing the plurality of spikes by scaling the plurality of spikes geometrically similarly, wherein a relationship of lengths of the plurality of spikes to widths of the plurality of spikes remains substantially the same.

4. The method according to claim 2, wherein increasing the induction factor comprises upsizing the plurality of spikes by increasing lengths of the plurality spikes while not changing widths of plurality of spikes.

5. The method according to claim 1, wherein increasing the induction factor comprises:
adjusting an installation angle of the sound-protection means, wherein the installation angle is defined as an angle between a local chord of the rotor blade and the sound-protection means, wherein the local chord is defined as direct connection of the leading edge and the trailing edge at a site of the sound-protection means.

6. The method according to claim 1, further comprising:
determining an influence of the air density on the propagated sound, and
optimizing the performance while considering the air density and a desired sound power level.

7. The method according to claim 6, wherein optimizing the performance comprises upsizing the sound-protection means.

8. The method according to claim 1, wherein increasing the induction factor comprises increasing a number of spikes of serrations in the sound-protection means in the rotor-blade longitudinal direction.

9. The method according to claim 1, wherein increasing the induction factor comprises upsizing the sound-protection means by a scaling factor varying in the rotor-blade longitudinal direction.

10. The method according to claim 9 wherein the scaling factor increases from the rotor-blade tip to an end of the sound-protection means.

11. The method according to claim 10, wherein the scaling factor at the rotor-blade tip is 1.

12. A rotor blade of a wind turbine comprising:
said rotor blade extends from a rotor-blade coupling to a rotor-blade tip in a rotor-blade longitudinal direction with a rotor-blade length, having an aerodynamical profile extending between a leading edge and a trailing edge,
wherein the rotor blade has a sound-protection means within a blade external region defined as 50% of the rotor-blade length abutting the rotor-blade tip,
wherein the sound-protection means is configured as serrations with several spikes arranged side by side in the rotor-blade longitudinal direction, wherein the rotor-blade longitudinal direction is arranged in a way that a serrated contour of the effective trailing edge is formed in a region of the sound-protection means,
wherein a design size is defined for the sound-protection means at which the rotor blade complies with a desired sound power level when to rotor blade is used at a design air density, and
wherein sound-protection means is larger than the design size when the air density is lower than the design air density.

13. A wind turbine comprising one or more rotor blades according to claim 12.

14. A wind farm comprising one or more wind turbines according to claim 13.
